(19) United States
(12) Patent Application Publication
(10) Pub. No.: US 2021/0327235 A1
(43) Pub. Date: Oct. 21, 2021

(54) METHOD AND A SYSTEM FOR INDICATING A SAFE EXIT ROUTE TO INFORM A USER

(71) Applicant: CARRIER CORPORATION, Palm Beach Gardens, FL (US)

(72) Inventor: Sumanth Kumar MUKUNDALA, Hyderabad (IN)

(21) Appl. No.: 17/115,331

(22) Filed: Dec. 8, 2020

(30) Foreign Application Priority Data
Apr. 20, 2020 (IN) 202011016916

(51) Int. Cl. G08B 17/00; G08B 21/02

(52) U.S. Cl. CPC G08B 17/00; G08B 21/02

(57) ABSTRACT

A system and a method for indicating a safe exit route to inform a user for exiting a premises in a fire event. A method includes receiving information associated with a fire event detected by a plurality of fire devices. The method further includes determining a safe exit route from a plurality of exit routes present in the premises using the information associated with the fire event. The method also includes providing an indication of the safe exit route by a plurality of accessing units.

### FOREIGN PRIORITY

This application claims priority to Indian Patent Application No. 202011016916, filed Apr. 20, 2020, and all the benefits accruing therefrom under 35 U.S.C. § 119, the contents of which in its entirety are herein incorporated by reference.

### TECHNICAL FIELD

The present invention generally relates to fire safety systems. More particularly, the invention relates to a system and a method for providing an indication of a safe exit route to inform a user for exiting a premises in a fire event.

### BACKGROUND

Safety of people present inside a building is of prime concern during any fire/smoke breakouts in the building. In order to ensure safety of people during such breakouts, several measures are taken. One such measure is the usage of a fire/smoke alarm system which activates a fire/smoke alarm and starts beeping when the fire/smoke alarm system detects fire/smoke in the building. The activation of the fire/smoke alarm informs people about fire/smoke breakouts so that people present inside the building may vacate the building as soon as possible. Further, people present inside the building mostly use exit routes (such as stairs) provided in the building to escape after the fire/smoke event. In particular, people may use a shortest or closest exit route to come out of the building.

However, when people take the exit routes to come out of the building, they do not know about an actual or a real-time status of the exit routes in the event of fire/smoke. Also, the people do not know if the fire/smoke has entered in the exit routes and are safe to use or not. This poses a huge risk to them as they may suffocate in the presence of fire/smoke present in these exit routes. Furthermore, it may be confusing for people to determine the better path amongst plurality of exit routes for safe exit.

In view of the afore-mentioned problems, there is a need of an efficient and effective system and a method for preventing people from taking an exit route where fire/smoke has already entered/present and at the same time allow them to take the optimal path. There is also a need to provide a solution for informing people about an exit route which is safe to use during a fire event. In order to solve the problems in the existing solutions, a system and a method are disclosed.

### SUMMARY

Various embodiments of the invention describe a system for providing an indication of a safe exit route to inform a user for exiting a premises in a fire event. The system comprises a plurality of fire devices adapted to detect a fire event in a premises and to transmit information associated with the fire event. The system further comprises a plurality of accessing units adapted to determine a safe exit route from a plurality of exit routes present in the premises using the information associated with the fire event and providing an indication of the safe exit route.

In an embodiment of the invention, the plurality of fire devices correspond to fire detectors or fire panels having a capability to detect the fire event and the plurality of accessing units correspond to locks.

In a different embodiment of the invention, the information associated with the fire event transmitted from each of the plurality of fire devices comprises fire intensity reading, a unique identifier of a fire device, a location of a fire device and/or a location of the fire event.

In an embodiment of the invention, the location of the fire event comprises location of a nearest fire device of the fire event.

In another embodiment of the invention, the plurality of fire devices are installed in the premises and directly communicate with the plurality of accessing units through a short-range network.

In yet another embodiment of the invention, the plurality of accessing units receive the information associated with the fire event from the plurality of fire devices through the short-range network.

In another embodiment of the invention, the plurality of fire devices communicate with the plurality of accessing units through a server.

In still another embodiment of the invention, the server determines the safe exit route from the plurality of exit routes present in the premises using the information associated with the fire event with respect to a digitized map of the premises.

In a different embodiment of the invention, the server transmits information of the safe exit route to the plurality of accessing units. Also, the plurality of accessing units provide the indication of the safe exit route based on the information of the safe exit route.

In another embodiment of the invention, the plurality of accessing units determine the safe exit route by using the information associated with the fire event with respect to a digitized map of the premises.

In yet another embodiment of the invention, each of the plurality of accessing units comprises a left semi-circular ring and a right semi-circular ring. Also, each of the left semi-circular ring and the right semi-circular ring provides the indication by glowing with a color.

In another embodiment of the invention, the left semi-circular ring or the right semi-circular ring glow with green color for indicating a direction of the safe exit route.

In an embodiment of the invention, the left semi-circular ring and the right semi-circular ring glow with the same color in a low-battery event or an invalid access event.

Various embodiments of the invention describe a method for providing an indication of a safe exit route to inform a user for exiting a premises in a fire event. The method comprises steps of receiving information associated with a fire event detected by a plurality of fire devices and determining a safe exit route from a plurality of exit routes present in a premises using the information associated with the fire event. The method comprises steps of providing an indication of the safe exit route by a plurality of accessing units.

In an embodiment of the invention, the plurality of fire devices are installed in the premises and directly communicate with the plurality of accessing units through a short-range network.

In a different embodiment of the invention, the plurality of fire devices communicate with the plurality of accessing units through a server.

In an embodiment of the invention, the information associated with the fire event transmitted from each of the plurality of fire devices comprises fire intensity reading, a unique identifier, a location of a fire device and/or a location of the fire event.

In another embodiment of the invention, each of the plurality of accessing units comprises a left semi-circular ring and a right semi-circular ring. Also, each of the left semi-circular ring and the right semi-circular ring provides the indication by glowing with a color.

In yet another embodiment of the invention, the left semi-circular ring or the right semi-circular ring glows with green color for indicating a direction of the safe exit route.

In another different embodiment of the invention, a computer readable medium is disclosed for providing an indication of a safe exit route to inform a user for exiting a premises in a fire event. The computer readable medium comprises one or more processors and a memory is coupled to the one or more processors, the memory stores instructions executed by the one or more processors. The one or more processors are configured to receive information associated with a fire event detected by a plurality of fire device and determine a safe exit route from a plurality of exit routes present in a premises using the information associated with the fire event. The one or more processors are configured to provide an indication of the safe exit route by a plurality of accessing units.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1A depicts an exemplary system architecture with fire event at a location in a premises according to an exemplary embodiment of the invention.

FIG. 1B depicts an exemplary system architecture with fire event at a different location in a premises according to an exemplary embodiment of the invention.

FIG. 2 depict an exemplary system architecture according to an exemplary alternative embodiment of the invention.

FIG. 3 depicts block diagram of different components of an exemplary accessing unit according to an exemplary embodiment of the invention.

FIG. 4 depicts an exemplary flowchart illustrating a method to perform the invention according to an exemplary embodiment of the invention.

Corresponding reference numerals indicate corresponding parts throughout the drawings.

### DETAILED DESCRIPTION

Described herein is the technology with a system and a method for indicating a safe exit route to inform a user for exiting a premises in a fire event. A user may be present inside a premises when a fire event emerges inside the premises. The premises may have a plurality of fire devices to detect the fire event in the premises. In an exemplary embodiment, the plurality of fire devices may determine and transmit information associated with the fire event to a plurality of accessing units through a short-range network. The information associated with the fire event may comprise fire intensity reading, a unique identifier of a fire device, a location of the fire device and/or a location of the fire event. In an exemplary embodiment, the location of the fire event may be considered as a location of a nearest fire device of the fire event which has reported or sensed highest fire intensity reading.

Using the information associated with the fire event with respect to a digitized map of the premises, the plurality of accessing units may determine a safe exit route from a plurality of exit routes present in the premises. In particular, the plurality of accessing units may use the location information associated with the fire event from each of the plurality of fire devices in a pre-stored digitized map of the premises. By doing this, the plurality of accessing units may determine a safe exit route which may be away from a location of the fire event or far from the fire device which has reported or sensed highest fire intensity reading. Further, the plurality of accessing units may provide an indication of the safe exit route to inform the user. The user may follow such indication to exit the premises using the safe exit route. In an exemplary embodiment, the safe exit route may be a route where the fire has not entered and is safe to use by the user inside the premises.

In an exemplary alternative embodiment, the plurality of fire devices may determine and transmit information associated with the fire event to a server through a network. Using the information associated with the fire event with respect to a digitized map of the premises, the server may determine a safe exit route from a plurality of exit routes present in the premises by plotting the information (i.e. fire intensity reading, location information, and the unique identifier) in a pre-stored digitized map of the premises. Then, the server may transmit information of the safe exit route to the plurality of accessing units through the network. Accordingly, the plurality of accessing units may provide an indication of the safe exit route to inform the user based on the information of the safe exit route.

As used herein, the plurality of fire devices may be fire detectors or fire control panels capable of detecting fire event and a location of the fire event inside the premises. Each of the plurality of fire devices may comprise, but is not limited to, a transceiver, sensor/s, a battery, a processor and/or a memory. The plurality of fire devices may be connected with the plurality of accessing units through a network. The plurality of fire device may also be connected with a server through a wired network or a wireless network. Few examples of the plurality of fire devices may include, but is not limited to, an ionization smoke detector, a photoelectric or an optical smoke detector, an aspirating smoke detector (ASD), optical flame detectors or any such device that is well known in the art.

As used herein, the plurality of accessing units may refer to locks. The plurality of accessing units may be installed inside the premises. In specific, the plurality of accessing units may be installed at a door of a room of the premises. Also, the plurality of accessing units may be communicably coupled with the plurality of fire devices and/or the server through a network. Further, the plurality of accessing devices may be communicably coupled with each other. The plurality of accessing units may comprise, but is not limited to, a transceiver, an interface, a determination unit, a battery, a processor and/or a memory.

As used herein, the premises may be a building, home, bank, office, mall, college, hospital and/or or any such premises having a plurality of exit routes where a fire event may occur. Further, the one or more fire devices may also be located or positioned/installed inside the premises.

As used herein, the server has processing capabilities as disclosed further in the specification. The server may be a cloud storage, a remote database, or any such storage known in the art.

As used herein, the network may refer to a wired network, a mesh network, a cellular network (such as Global System for Mobile (GSM) network, a Long-Term Evolution (LTE) network, a code-division multiple access (CDMA) network, a narrow-band internet of thing (NB-IoT) technique or category M1 technique)), a short-range network (a bluetooth network, a WiFi network, or a ZigBee network) or any such network/technique that is known in the art.

Throughout the specification, reference numeral 104 depicts all rooms. Each of the reference numerals 104A-104E may be considered as a separate room. Likewise, throughout the specification, reference numeral 106 depicts all accessing units. Each of the reference numerals 106A-106E may be considered as a separate accessing unit. Also, throughout the specification, reference numeral 108 depicts all fire devices. Each of the reference numerals 108A-108F may be considered as a separate fire device.

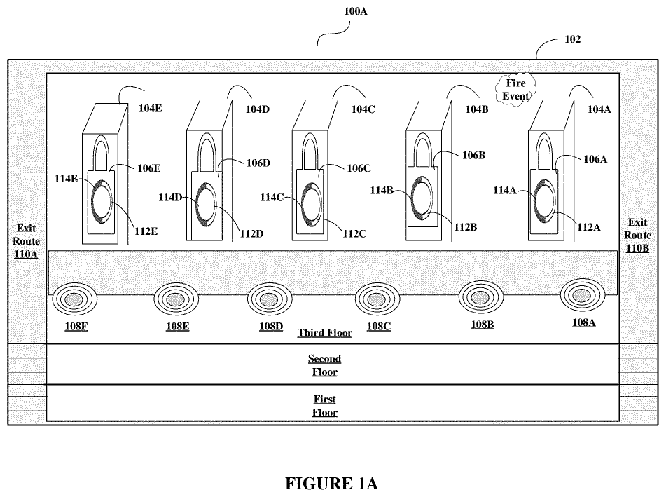

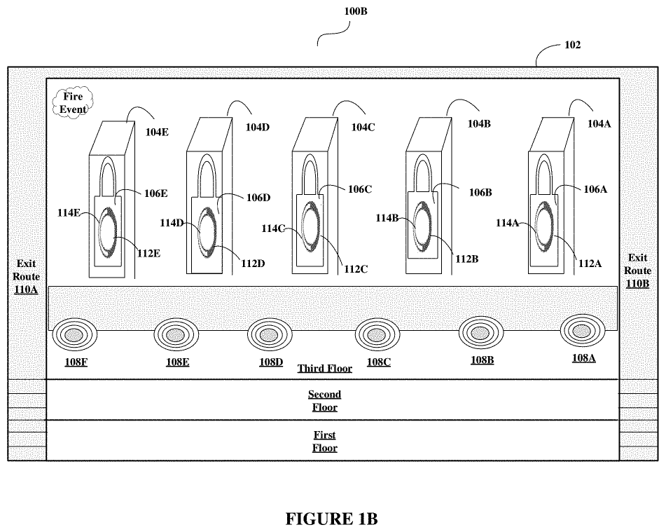

FIG. 1A depicts an exemplary system architecture 100A with a fire event occurred at a location in a premises according to an exemplary embodiment of the invention. As depicted in FIG. 1A, a premises 102 may have a plurality of floors, namely a first floor, a second floor and a third floor. Each of the floor in the premises may have a plurality of rooms 104 with a plurality of accessing units 106. For an instance, at the third floor of the premises 102, a first accessing unit 106A may be positioned/installed at a door of a first room 104A, a second accessing unit 106B may be installed at a door of a second room 104B, a third accessing unit 106C may be installed at a door of a third room 104C, a fourth accessing unit 106D may be installed at a door of a fourth room 104D, and a fifth accessing unit 106E may be installed at a door of a fifth room 104E. Moreover, at the third floor, a plurality of fire devices 108A-108F may also be installed. In this example, there are six fire devices 108A-108F installed at the third floor. In addition, the premises 102 may have a plurality of exit routes 110, namely a first exit route 110A and a second exit route 110B. In the same way, at each floor, several fire devices and the accessing units may be installed. However, various other configurations of the accessing devices and the fire devices are within the scope of the invention.

Considering an exemplary scenario where a fire event may occur at the third floor between the first room 104A and the second room 104B as depicted in FIG. 1A. The plurality of fire devices 108A-108F installed at the third floor may detect the fire event at the third floor using sensor/s embedded in the each of plurality of fire devices 108A-108F. In an exemplary embodiment, the plurality of fire devices 108A-108F correspond to fire detectors or fire panels having a capability to detect the fire event. The plurality of fire devices 108A-108F may determine information associated with the fire event. In an exemplary embodiment, the information associated with the fire event may comprise fire reading, a unique identifier of a fire device 108, a location of the fire device 108 and/or a location of the fire event. In an exemplary embodiment, the location of the fire devices 108 may be determined by using a global positioning system (GPS) or an indoor positioning system. In an alternative embodiment, the location information of the fire device may be determined by using the unique identifier associated with the fire device. It is to be noted that other ways or means of determining the location of the fire device 108 are covered with the scope of the present invention.

In order to determine the information associated with the fire event, each of the plurality of fire devices 108A-108F may use sensor/s, a location determining module, a processor to determine fire readings, its own location, location of the fire event and its unique identifier and a memory to store and information related to different parameters. Considering an exemplary Table 1 below showing the information associated with the fire event determined by each of the fire devices 108A-108F.

TABLE 1
Third Floor

| Unique | Readings of | |
|---|---|---|
| Identifier of | Fire (i.e. | |
| Fire device | Intensity) | Location of Fire device |
| 108A | 48 | Near to first room 104A |
| 108B | 50 | In between first room 104A |
| | | and second room 104B |
| 108C | 40 | In between second room 104B |
| | | and third room 104C |
| 108D | 32 | In between third room 104C |
| | | and fourth room 104D |
| 108E | 21 | Near to fourth room 104D |
| 108F | 10 | Near to fifth room 104E |

The intensity of fire may be measured in KW/m² unit. The values used in Table 1 and the specification are exemplary and any other modification in the values are within the scope of this invention. Although the exemplary Table 1 above shows fire intensity readings, unique identifier and location; however, other parameters such as temperature, smoke intensity and the like are within the scope of the invention.

In an exemplary embodiment, the plurality of the fire devices 108 may determine a location of the fire event. The location of the fire event may comprise location of a nearest fire device of the fire event which has reported or sensed highest fire intensity reading. Considering the example in Table 1 above and based on the highest fire intensity reading, the location of the fire event may be determined by considering a location of the fire device 108B which reported the highest fire intensity reading. Thereby, in this example, the location of the fire event may be determined as approximately “in between the first room 104A and the second room 104B”.

Also, the plurality of fire devices 108A-108F may transmit the determined information associated with the fire event to the plurality of accessing units 106. In an exemplary embodiment, the plurality of fire devices 108A-108F may communicate directly with the plurality of the accessing units 106 through a short-range network (such as a Wi-Fi network or a bluetooth network). In this embodiment, the fire devices 108A-108F may directly communicate with the plurality of accessing units 106 only if they are bluetooth or Wi-Fi enabled. For an example, the plurality of fire devices 108A-108F may transmit the determined information associated with the fire event only to a plurality of accessing units which may be located opposite to room/s in which one or more user/s are present. When the one or more user/s come out of their respective room/s, the user/s may see indication of a safe exit route on those accessing units located opposite to their room/s.

The plurality of the accessing units 106 receive the information from the fire devices 108 and may determine a safe exit route from a plurality of exit routes 110A-110B present in the premises 102 using the received information. The safe exit route is determined by mapping a relative location of the fire event with respect to a digitized map of the premises 102. For this, the plurality of accessing units 106 may plot the information associated with the fire event (i.e. location of the fire event, the location of fire devices, the fire intensity reading and the unique identifier) in a pre-stored digitized map of the premises 102. Accordingly, the safe exit route from the plurality of exit routes 110A-110B may be determined. In an exemplary embodiment, the plurality of accessing units 106 may correspond to locks.

The plurality of the accessing units 106 may use the plotted/mapped information on the digitized map to calculate a distance between the location of the fire event and a location of each of the plurality of exit routes 110A-110B for determining a safe exit route. The plurality of the accessing units 106 may prioritize each of the plurality of exit routes 110A-110B based on the calculated distance. Considering the same example as explained above where the plurality of the accessing units 106 determine the location of the fire event at “in between the first room 104A and the second room 104B”. In this example, the plurality of the accessing units 106 may assign high priority to the first exit route 110A since the distance between a location of the first exit route 110A and the location of the fire event is greater or maximum as compared to the second exit route 110B. Thereby, the plurality of the accessing units 106 may determine the first exit route 110A as a safe exit route which is present (or located) near to the fifth room 104E as the location of the fire event is in between the first room 104A and the second room 104B. In other words, the plurality of the accessing units 106 determine the safe exit route which may be located away from the location of the fire event.

When the plurality of the accessing units 106 determine the safe exit route 110A, the plurality of the accessing units 106 may provide an indication of the safe exit route 110A for informing a user to exit the premises 102 using the safe exit route 110A. In an exemplary embodiment, the plurality of the accessing units 106 may provide an indication of the safe exit route 110A by displaying (i.e. continuously glowing or blinking color) the indication on the plurality of the accessing units 106 for the user. In another exemplary embodiment, the plurality of the accessing units 106 may provide an indication of the safe exit route 110A by producing sound or outputting voice commands for the user. Further, each of the plurality of the accessing units 106 may comprise a left semi-circular ring 114 and a right semi-circular ring 112. In specific, the first accessing unit 106A may comprise a left semi-circular ring 114A and a right semi-circular ring 112A. The second accessing unit 106B may comprise a left semi-circular ring 114B and a right semi-circular ring 112B and the third accessing unit 106C may comprise a left semi-circular ring 114C and a right semi-circular ring 112C. Lastly, the fourth accessing unit 106D may comprise a left semi-circular ring 114D and a right semi-circular ring 112D and the fifth accessing unit 106E may comprise a left semi-circular ring 114E and a right semi-circular ring 112E.

Each of the left semi-circular ring 114 and the right semi-circular ring 112 may provide an indication by glowing with a color based on the location of the fire event. In an exemplary embodiment, either the left semi-circular ring 114 or the right semi-circular ring 112 may glow with green color light for displaying the indication of the safe exit route 110A. As depicted in FIG. 1A, each of the left semi-circular ring 114A-114E are glowing with a color (i.e. green color light) as the safe exit route 110A (as determined by the accessing unit 106) which is towards the left direction of the premises 102 and is away from the location of the fire event. By glowing each of the left semi-circular ring 114A-114E with the green color light, the plurality of the accessing units 106 provide an indication of the safe exit route 110A (i.e. towards the left direction) for indicating a direction of the safe exit route 110A for informing the user to exit the premises 102 using the safe exit route 110A. Also, in such a situation, the each of the right semi-circular ring 112A-112E may not glow with any color light. This embodiment of the present invention provides technical advantage of providing clear and explicit indication to the user for exiting the premises 102 using the safe exit route 110A.

FIG. 1B depicts an exemplary system architecture 100B with fire event at a different location in a premises according to an exemplary embodiment of the invention. As can be seen that a fire event may occur at the third floor and at the left side of the fifth room 104E. The plurality of fire devices 108A-108F may detect the fire event at the third floor and may determine information associated with the fire event. Considering an exemplary Table 2 below showing the information associated with the fire event determined by each of the fire devices 108A-108F.

TABLE 2
Third Floor

| Unique | Readings of | |
|---|---|---|
| Identifier of | Fire (i.e. | |
| Fire device | Intensity) | Location of Fire device |
| 108A | 10 | Near to first room 104A |
| 108B | 21 | In between first room 104A |
| | | and second room 104B |
| 108C | 31 | In between second room 104B |
| | | and third room 104C |
| 108D | 37 | In between third room 104C |
| | | and fourth room 104D |
| 108E | 43 | Near to fourth room 104D |
| 108F | 50 | Near to fifth room 104E |

The plurality of the fire devices 108A-108F may determine location of the fire event as explained in FIG. 1A above. Referring to exemplary Table 2 above, the plurality of the fire devices 108A-108F may determine location of the fire event as approximately “Near to the fifth room 104E” since the fire device 108F has reported highest fire reading of 50. Also, each of the plurality of fire devices 108A-108F may transmit the determined information (i.e. the location of the fire event, the location of the fire device, fire intensity readings and its unique identifier) associated with the fire event to the plurality of the accessing units 106 through a short-range network (such as a Wi-Fi network or a bluetooth network).

Further, the plurality of the accessing units 106 may determine a safe exit route from a plurality of exit routes 110A-110B present in the premises 102 using the information associated with the fire event (as explained in FIG. 1A above). Considering the same example of Table 2 as explained above where the location of the fire event is determined as “Near to the fifth room 104E”. For this, the plurality of accessing units 106 may plot/map the information associated with the fire event (i.e. location of the fire event, the location of fire devices, the fire intensity reading and the unique identifier) in the pre-stored digitized map of the premises 102. The plurality of the accessing units 106 may use the plotted information on the digitized map to calculate a distance between the location of the fire event and a location of each of the plurality of exit routes 110A-110B for determining a safe exit route.

In this example, the plurality of the accessing units 106 may determine the second exit route 110B as a safe exit route which is present (or located) far away from the fifth room 104E as the location of the fire event is near to the fifth room 104E. Moreover, the plurality of the accessing units 106 may provide an indication of the safe exit route 110B for informing the user to exit the premises 102 using the safe exit route 110B. As depicted in FIG. 1B, each of the right semi-circular ring 112A-112E is glowing with a color (i.e. green color light) as the safe exit route 110B (as determined by the accessing unit 106) which is towards the right direction of the premises 102 and is away from the location of the fire event. By glowing each of the right semi-circular ring 112A-112E with the green color light, the plurality of the accessing units 106 provide an indication of the safe exit route 110B (i.e. towards the right direction) for informing the user to exit the premises 102 using the safe exit route 110B.

The present invention encompasses each of the left semi-circular ring 114 and the right semi-circular ring 112 to glow with green color light at the same time when at both the sides (at left and right sides), there exists a safe exit route. The user inside the premises 102 may use any safe exit route at any left and right sides to exit the premises 102. Further, such color light on each of the left semi-circular ring 114 and the right semi-circular ring 112 may go off when the fire event is ceased. The indication of the direction of the safe exit route by various other colors is also within the scope of the invention.

The present invention further encompasses each of the left semi-circular ring 114 and the right semi-circular ring 112 to glow with red color light at the same time in a low-battery event or an invalid access event. The low-battery event may correspond to an event when a battery of an accessing unit 106 becomes low. The invalid access event may correspond to an event when a user uses a wrong access card to unlock the accessing unit 106 or when an invalid access card is presented to an accessing unit 106. Alternatively, if a valid access card is presented to an accessing unit 106, the accessing unit 106 may glow with green color light in both of the left semi-circular ring 114 and the right semi-circular ring 112. The accessing unit 106 may glow red flashing light when the accessing unit 106 has the low battery event followed by a green flashing light when the valid keycard is presented.

The present invention also encompasses the plurality of accessing units 106 to provide indication of a first safe exit route at one time and to provide indication of a second safe exit route at another time when there are more than one safe exit routes exist. This would provide more options to the user to exit the premises 102. It is within the scope of the present invention that the plurality of accessing units 106 at one floor may provide different indications of safe exit routes as compared to a plurality of accessing units 106 at another floor. Such different indications may entirely depend on the location of the fire event and the location of each of the plurality of exit routes 110.

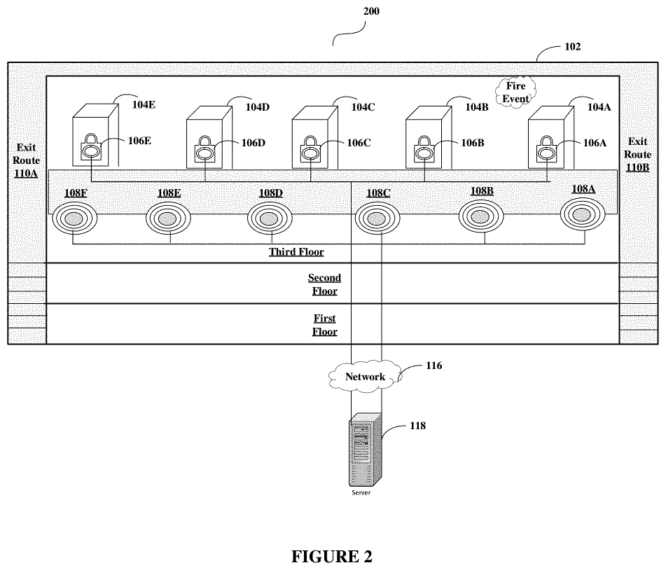

FIG. 2 depict an exemplary system architecture 200 according to an exemplary alternative embodiment of the invention. In this alternative embodiment of the present invention, each of the fire devices 108A-108F may be connected with a server 118 through a network 116. The plurality of fire devices 108A-108F may determine information (i.e. fire intensity reading, a unique identifier of a fire device and/or a location of a fire event, a location of a fire device) associated with a fire event. Then, the plurality of fire devices 108A-108F may transmit the determined information associated with the fire event to the server 118 through the network 116. In this embodiment, the communication between the server 118 and the plurality of fire devices 108A-108F may be bluetooth/BT repeaters, Wi-Fi or any other network as described above if the range is not subsistence.

Further, the server 118 may determine a safe exit route from a plurality of exit routes 110A-110B present in the premises 102 using the information associated with the fire event with respect to a digitized map of the premises 102. The server 118 may also have a pre-stored digitized map of the premises 102. For this, the server 118 may perform same functions and operations as performed by the plurality of the accessing units 106 (in FIGS. 1A and 1B above) to determine the safe exit route. Then, the server 118 may transmit information to each of the plurality of accessing units 106 with instructions to display indication on the first semicircular ring 112 or the second circular ring 114 in a particular direction. The display of indication on the first semicircular ring 112 or the second semicircular ring 114 constitutes the safe exit route. Accordingly, the plurality of accessing units 106 may provide an indication of the safe exit route based on the information of the safe exit route as explained in FIGS. 1A and 1B above.

Although the FIGS. 1A, 1B and 2 show two exit routes with six fire devices 108 and five accessing units 106 and five rooms 104; however, it is understood for a person skilled in the art that any number of exit routes having any number of rooms, fire devices and the accessing units may be present inside the premises.

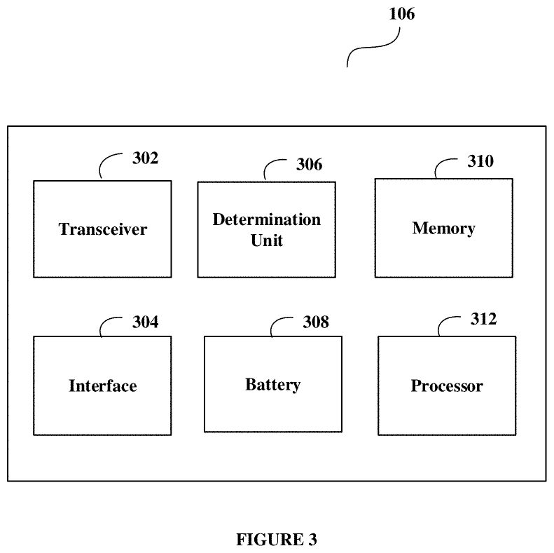

FIG. 3 depicts block diagram of different components of an exemplary accessing unit 106 according to an exemplary embodiment of the invention. The accessing unit 106 may comprise of, but is not limited to, a transceiver 302, an interface 304, a determination unit 306, a battery 308, a memory 310 and/or a processor 312. The transceiver 302 may be adapted to receive information associated with a fire event from a plurality of fire devices 108. The transceiver 302 may communicate the information associated with the fire event to the determination unit 306. The determination unit 306 may be adapted to determine a safe exit route from a plurality of exit routes 110A-110B present in the premises 102 102 using the information associated with the fire event as explained in FIGS. 1A and 1B above. The determination unit 306 may also communicate the safe exit route to the interface 304. The interface 304 may comprise a left semi-circular ring 114 and a right semi-circular ring 112 to provide an indication of the safe exit route for informing a user to exit the premises 102 using the safe exit route. The interface 304 may also output voice command/s to provide an indication of the safe exit route for informing the user to exit the premises 102. The battery 308 may be adapted to provide power to the accessing unit 106. The memory 310 may be adapted to store the information associated with the fire event and/or the determined safe exit route.

Moreover, the transceiver 302, the interface 304, the determination unit 306, the battery 308, the memory 310 may be communicably coupled with the processor 312. The different units described herein are exemplary. The invention may be performed using one or more units. For example, the tasks executed by the transceiver 302, the interface 304, the determination unit 306, the battery 308, the memory 310 and/or the processor 312 may be performed by a single unit. Alternatively, more number of units as described herein may be used to perform the present invention.

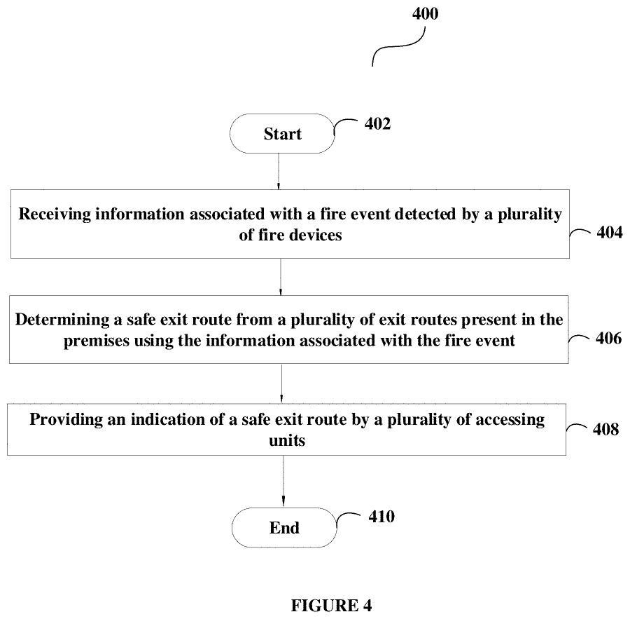

FIG. 4 depicts a flowchart outlining the features of the invention in an exemplary embodiment of the invention. The method flowchart 400 describes a method being for indicating a safe exit route to inform a user for exiting a premises 102 in a fire event. The method flowchart 400 starts at step 402.

At step 404, a plurality of accessing unit 106 may receive information associated with a fire event detected by a plurality of fire devices 108. This has been discussed in greater details in FIG. 1A, FIG. 1B and FIG. 2.

At step 406, the plurality of accessing unit 106 may determine a safe exit route from a plurality of exit routes 110A-110B present in the premises 102 using the information associated with the fire event. This has been discussed in greater details in FIG. 1A and FIG. 1B.

At step 408, the plurality of accessing unit 106 may provide an indication of a safe exit route. This has been discussed in greater details in FIG. 1A and FIG. 1B. Then, the method flowchart 400 may end at 410.

The present invention is applicable in various industries/fields such as, but not limited to, banking industry, hospitality industry, housing industry, building/construction industry, offices, universities, hospitals, colleges, homes and any such industry/field that is well known in the art and where fire may occur.

The embodiments of the invention discussed herein are exemplary and various modification and alterations to a person skilled in the art are within the scope of the invention.

In one embodiment of the invention, the invention can be operated using the one or more computer readable devices. The one or more computer readable devices can be associated with an accessing unit 106. A computer readable medium comprises one or more processors and a memory coupled to the one or more processors, the memory stores instructions executed by the one or more processors. The one or more processors configured to receive information associated with a fire event detected by a plurality of fire devices 108. The one or more processors also configured to determine a safe exit route from a plurality of exit routes 110A-110B present in the premises 102 using the information associated with the fire event. The one or more processors also configured to display an indication of the safe exit route by a plurality of accessing units 106.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A system comprising:
a plurality of fire devices adapted to detect a fire event in a premises and transmit information associated with the fire event; and
a plurality of accessing units, the plurality of accessing units corresponding to locks, the plurality of accessing units adapted to:
determine a safe exit route from a plurality of exit routes present in the premises using the information associated with the fire event; and
provide a visual indication of the safe exit route at the plurality of accessing units.

2. The system of claim 1, wherein the plurality of fire devices correspond to fire detectors or fire panels having a capability to detect the fire event.

3. The system of claim 1, wherein the information associated with the fire event transmitted from each of the plurality of fire devices comprises fire intensity reading, a unique identifier of a fire device, a location of a fire device and/or a location of the fire event.

4. The system of claim 3, wherein the location of the fire event comprises a location of a nearest fire device of the fire event.

5. The system of claim 1, wherein the plurality of fire devices are installed in the premises and directly communicate with the plurality of accessing units through a short-range network.

6. The system of claim 5, wherein the plurality of accessing units receive the information associated with the fire event from the plurality of fire devices through the short-range network.

7. The system of claim 1, wherein the plurality of fire devices communicate with the plurality of accessing units through a server.

8. The system of claim 7, wherein the server determines the safe exit route from the plurality of exit routes present in the premises using the information associated with the fire event with respect to a digitized map of the premises.

9. The system of claim 8, wherein the server transmits information of the safe exit route to the plurality of accessing units, the plurality of accessing units provide the indication of the safe exit route based on the information of the safe exit route.

10. The system of claim 1, wherein the plurality of accessing units determine the safe exit route by using the information associated with the fire event with respect to a digitized map of the premises.

11. The system of claim 1, wherein each of the plurality of accessing units comprises a left semi-circular ring and a right semi-circular ring, wherein each of the left semi-circular ring and the right semi-circular ring provides the visual indication by glowing with a color.

12. The system of claim 11, wherein the left semi-circular ring or the right semi-circular ring glow with green color for indicating a direction of the safe exit route.

13. The system of claim 11, wherein the left semi-circular ring and the right semi-circular ring glow with the same color in a low-battery event or an invalid access event.

14. A method comprising:
receiving information associated with a fire event detected by a plurality of fire devices;
determining a safe exit route from a plurality of exit routes present in a premises using the information associated with the fire event; and
providing a visual indication of the safe exit route by a plurality of accessing units, the plurality of accessing units corresponding to locks.

15. The method of claim 14, wherein the plurality of fire devices are installed in the premises and directly communicate with the plurality of accessing units through a short-range network.

16. The method of claim 14, wherein the plurality of fire devices communicate with the plurality of accessing units through a server

17. The method of claim 14, wherein the information associated with the fire event transmitted from each of the plurality of fire devices comprises fire intensity reading, a unique identifier, a location of a fire device and/or a location of the fire event.

18. The method of claim 14, wherein each of the plurality of accessing units comprises a left semi-circular ring and a right semi-circular ring, wherein each of the left semi-circular ring and the right semi-circular ring provides the visual indication by glowing with a color.

19. The method of claim 18, wherein the left semi-circular ring or the right semi-circular ring glows with green color for indicating a direction of the safe exit route.

20. A computer readable medium comprising one or more processors and a memory coupled to the one or more processors, the memory storing instructions executed by the one or more processors, the one or more processors configured to:
receive information associated with a fire event detected by a plurality of fire devices;
determine a safe exit route from a plurality of exit routes present in a premises using the information associated with the fire event; and
provide a visual indication of the safe exit route by a plurality of accessing units, the plurality of accessing units corresponding to locks.
